(19) United States
(12) Patent Application Publication
(10) Pub. No.: US 2015/0281851 A1
(43) Pub. Date: Oct. 1, 2015

(54) HEARING AID

(71) Applicant: Kuo-Ping Yang, (US)

(72) Inventors: Tzu-Chien TZENG, Taipei (TW); Kuan-Li CHAO, Taipei (TW); Neo Bob Chih-Yung YOUNG, Taipei (TW); Kuo-Ping YANG, Taipei (TW)

(73) Assignee: Kuo-Ping Yang, Taipei (TW)

(21) Appl. No.: 14/294,332

(22) Filed: Jun. 3, 2014

(30) Foreign Application Priority Data
Mar. 27, 2014 (TW) 103111372

(51) Int. Cl. H04R 25/00

(52) U.S. Cl. CPC H04R 25/00

(57) ABSTRACT

A hearing aid includes at least two magnetic sensors, and the arrangements thereof are not parallel to each other so that the magnetic field can be detected more precisely to generate a clearer sound signal. Furthermore, the hearing aid can switch between two different receiving states according to different ways of generating sound signals, wherein the first receiving state generates a sound signal through the detection of the magnetic field and the second receiving state generates a sound signal through a microphone receiving sounds.

### BACKGROUND OF THE INVENTION

1. Field of the Invention

The present invention relates to a hearing aid, and especially to a method and a device for detecting magnetic fields that can be used to enhance the function of the hearing aid, precisely detect magnetic fields around the hearing aid device, and simultaneously provide a control function to shift the present invention to a traditional hearing aid mode.

2. Description of the Related Art

A traditional hearing aid and a cochlear implant apply telecoils to detect magnetic fields in low-frequency external hearing aid devices or other compatible hearing aid devices (such as a speaker of a telephone). After the magnetic field is transformed to an electrical signal and amplified, the signal can be (1) transformed to a sound signal via earphones (or a speaker) and transmitted to the ears of the user who wears a hearing aid; or (2) transformed to an electric pulse signal by a cochlear implant to stimulate auditory nerves. The magnetic field signal detected by a telecoil, also called a T-coil, is the magnetic flux passing through the solenoid. When the magnetic force lines are totally parallel to the axial direction of a T-coil, the output signals are the maximum, but when the magnetic force lines are perpendicular to the axial direction of a T-coil, there are no output signals.

In other words, when the axial direction of a T-coil of a traditional hearing aid or a cochlear implant is not totally parallel to the magnetic force lines of a speaker of a telephone (or a meeting room with hearing loops), there might be some errors in the detected magnetic field signals, and the sound heard might be influenced as well. Therefore, the method of a hearing aid detecting magnetic fields needs to be improved.

### SUMMARY OF THE INVENTION

The primary object of the present invention is to provide a hearing aid generating sound signals through magnetic field detection, wherein the magnetic sensors thereof can improve the function of detecting magnetic fields of the hearing aid.

Another object of the present invention is to provide a hearing aid which can switch the ways of generating sound signals, including detecting magnetic fields or receiving sounds via a microphone. The above-mentioned ways are respectively defined as a first receiving state and a second receiving state.

To achieve the above-mentioned objects, the hearing aid of the present invention includes a sound processing module, a control module, an amplifier, a microphone, a speaker, a signal processing module and a plurality of magnetic sensors.

According to the embodiment of the present invention, the control module is used to control the change between the first receiving state and the second receiving state, wherein in the first receiving state, the plurality of magnetic sensors are used to detect magnetic fields and generate a plurality of magnetic field signals. The magnetic field signals are then received by the signal processing module and a calculation module calculates a magnetic field signal sum, which is then transmitted to the sound signal generator module to generate a first sound signal. The first sound signal is then transmitted to the amplifier 30 for increasing the volume and to the speaker 50 for playing; in the second receiving state, the microphone is used to receive an external sound and generate a third sound signal, which is then transmitted to the sound processing module. The module processes the third sound signal with frequency processing so as to generate a fourth sound signal. Then the fourth sound signal is transmitted to the amplifier for increasing the volume and to the speaker for playing.

According to another embodiment of the present invention which is unlike the previous embodiment, in the first receiving state, an additional sound processing module is used to process the frequency of sound signals with frequency lowering or frequency shifting. The magnetic field signal sum calculated by the calculation module is transmitted to the sound signal generator module to generate a first sound signal G1, which is then transmitted to the sound processing module for frequency processing to generate a second sound signal G2, which is then transmitted to the amplifier for increasing the volume and last to the speaker for playing.

The magnetic sensors of the present invention are at least 2 in number and are not mutually parallel such that the magnetic field can be detected more precisely to generate clearer sound signals to solve the problem that the traditional hearing aid detects magnetic fields in only one direction and produces unclear sound signals. The material of the magnetic sensors may provide high permeability so as to increase the precision when detecting the magnetic field.

### BRIEF DESCRIPTION OF THE DRAWINGS

These and other objects and advantages of the present invention will become apparent from the following description of the accompanying drawings, which disclose several embodiments of the present invention. It is to be understood that the drawings are to be used for purposes of illustration only, and not as a definition of the invention.

FIG. 1 presents a block diagram of the circuit of the hearing aid according to the present invention.

FIG. 2 presents a schematic figure of the hearing aid showing the process of the hearing aid detecting the magnetic field and transmitting signals according to the present invention.

FIG. 3 presents a schematic figure of the hearing aid showing the process of the hearing aid detecting the magnetic field and transmitting signals with a function executing frequency processing on sound signals according to the present invention.

FIG. 4 presents a schematic figure of the hearing aid showing the process of the hearing aid receiving sounds via a microphone and amplifying sound signals according to the present invention.

### DETAILED DESCRIPTION OF THE PREFERRED EMBODIMENT

To clarify the above and other purposes, features, and advantages of this invention, a specific embodiment of this invention is especially listed and described in detail with the attached figures as follows.

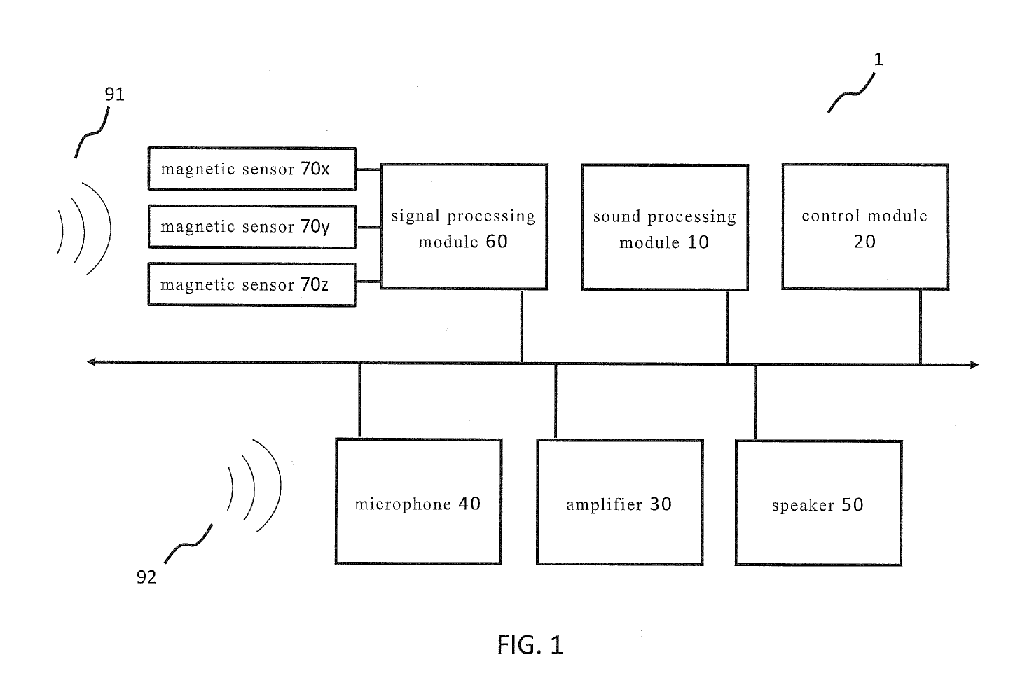

Please refer to FIG. 1, which shows a block diagram of the circuit of the hearing aid according to the present invention. The hearing aid 1 comprises a sound processing module 10, a control module 20, an amplifier 30, a microphone 40, a speaker 50, a signal processing module 60, and magnetic sensors 70x, 70y, 70z.

The hearing aid 1 is able to detect a magnetic field 91 to generate sound signals, or is able to receive external sounds 92 to generate sound signals. In a traditional telephone, for example, magnetic field flows change and influence the magnetic force of an electromagnet to generate a magnetic field 91. The external sound 92 may be environmental sounds, the sound from a speaker of a telephone, or the sounds of people talking.

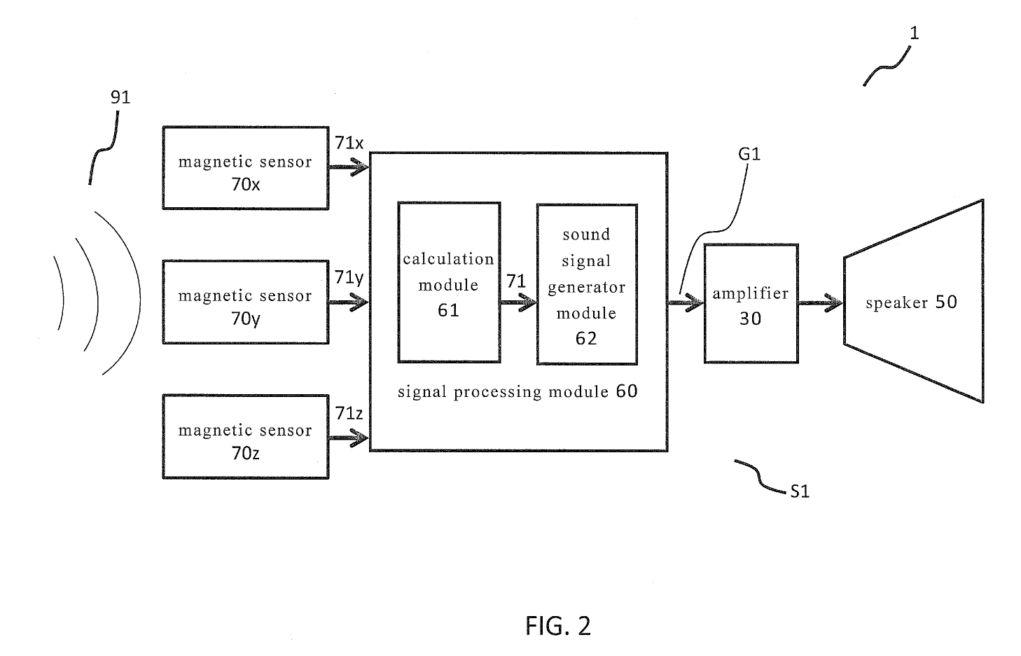

Please refer to FIG. 2, which is a first embodiment of a hearing aid 1 receiving a sound signal through a magnetic field 91, called first receiving state S1. The magnetic sensors 70x, 70y, 70z are also called M-sensors (Magnetic Sensors), and they are used to detect the magnetic field 91 to generate a plurality of magnetic field signals 71x, 71y, 71z. The magnetic sensors used by smart phones are appropriate for use as the magnetic sensors 70x, 70y, 70z due to their small volume and low price resulting from mass production. The ways to detect magnetic fields include the Hall Effect, magneto-impedance effect, magneto-resistance effect, or micro fluxgate, but do not include the T-coil used by traditional hearing aids. In addition, the material of the magnetic sensors 70x, 70y, 70z may be a high permeability material, such as mu-metal or permalloy, so as to magnify the magnetic field and increase the precision of the magnetic field detection.

The magnetic sensors 70x, 70y, 70z in the hearing aid 1 use 3 magnetic sensors to position magnetic force lines in a 3-dimensional space. Other arrangements include at least 2 magnetic sensors being mutually perpendicular or not mutually parallel. In the preferred embodiment, the hearing aid 1 uses 3 magnetic sensors that are mutually perpendicular because no matter what direction the magnetic field 91 is, the calculation module 61 can obtain the best signals when calculating the vectors of magnetic forces.

The signal processing module 60 is connected to the plurality of magnetic sensors 70x, 70y, 70z to receive magnetic field signals 71x, 71y, 71z. The calculation module 61 in the module calculates the direction and the position of the highest magnetic flux according to the magnetic field signals 71x, 71y, 71z detected by the magnetic sensors in different positions, such that the angle of the strongest magnetic field and the vector and magnitude of the strongest signal sum can be calculated to generate a magnetic field signal sum 71. The magnetic field signal sum 71 is then transmitted to the sound signal generator module 62 to generate a first sound signal G1, and the first sound signal G1 is transmitted to the signal to the amplifier 30 for increasing the volume and to the speaker 50 for playing. In reality, the magnetic force lines of the speaker of a telephone are not like those of a traditional hearing aid, which is only able to detect a stable direction of a magnetic field and thus influences the sound signal generation, but can be detected and calculated with the maximum value of magnetic field signal in various directions. The method of calculating the angle and magnitude of the strongest signal sum of a plurality of magnetic force vectors is a prior art, so the details thereof are omitted here.

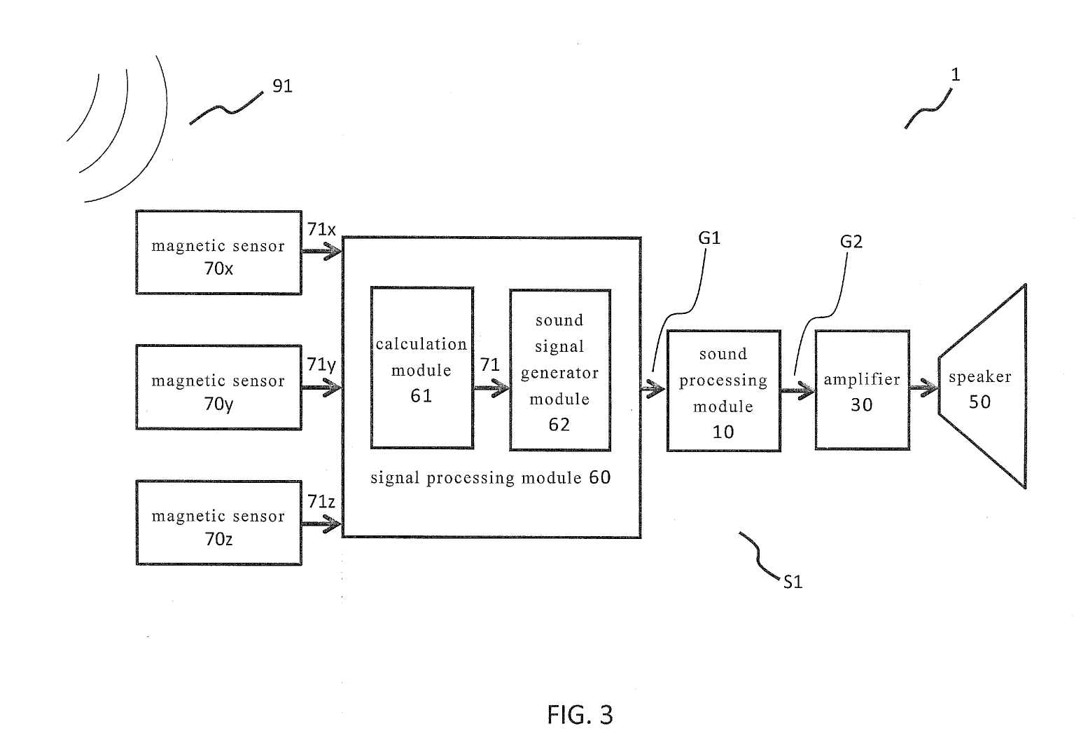

Please refer to FIG. 3, which is a second embodiment of a process of a hearing aid 1 detecting a magnetic field and transmitting a signal in the first receiving state S1. The hearing aid 1 provides a function of processing the frequency of sound signals, and the only difference from that in FIG. 2 is that an additional sound processing module 10 is used to process the frequency of sound signals with frequency lowering or frequency shifting. In the embodiment, the magnetic field signal sum 71 calculated by the calculation module 61 is transmitted to the sound signal generator module 62 to generate a first sound signal G1, which is then transmitted to the sound processing module 10 for frequency processing to generate a second sound signal G2, which is then transmitted to the amplifier 30 for increasing the volume and finally to the speaker 50 for playing. The rest of elements, functions, and signals are the same as those in FIG. 2. In general, hearing-impaired listeners (including the elderly) cannot hear high frequency sounds clearly, so the sound processing module 10 processes the first sound signal G1 with frequency lowering to generate the second sound signal G2. The method of executing a frequency lowering processing is not the focus of the present invention and is also a prior art, so the details thereof are omitted here.

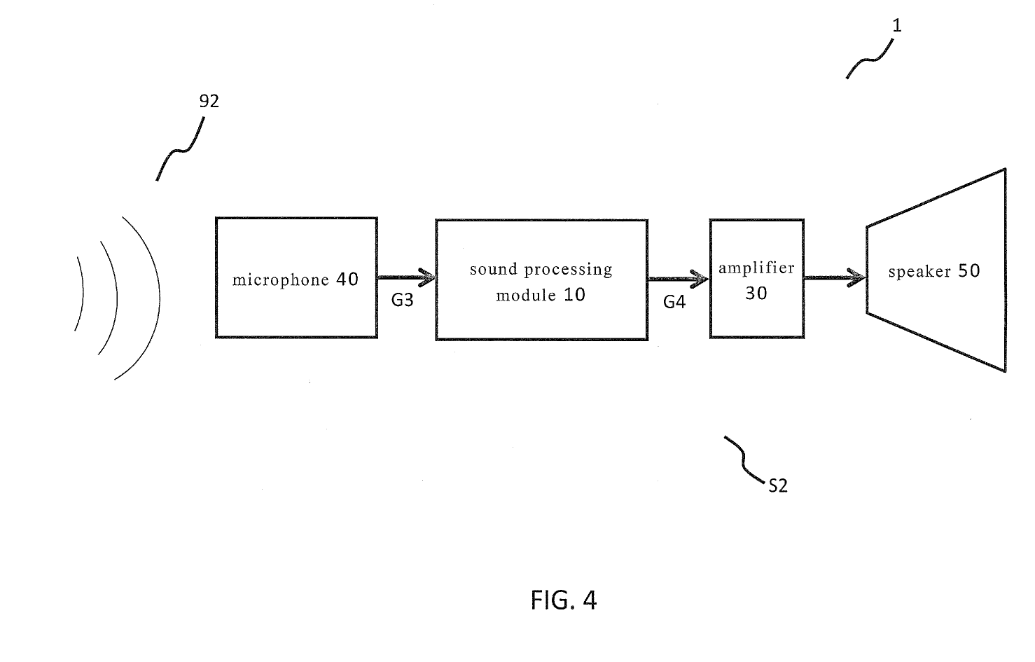

Please refer to FIG. 4, which is a process of a hearing aid 1 receiving sounds and amplifying sound signals via a microphone, called the second receiving state S2. The microphone 40 is used to receive an external sound 92 and to generate a third sound signal G3, which is then transmitted to the sound processing module 10. The module processes the third sound signal G3 with frequency processing so as to generate a fourth sound signal G4, which is able to help hearing-impaired listeners hear more clearly. Then the fourth sound signal G4 is transmitted to the amplifier 30 for increasing the volume and to the speaker 50 for playing. The second receiving state S2 is a common process in a normal hearing aid, so the details thereof are omitted here.

The control module 20 of the hearing aid 1 may be electrically connected to the magnetic sensors 70x, 70y, 70z, signal processing module 60, microphone 40 or sound processing module 10 such that one of the above can be activated or deactivated by the control module 20. The user can use the hearing aid 1 to the detect magnetic fields 91 to generate sound signals in the first receiving state S1 as in FIG. 2 or FIG. 3, or to receive sounds via the microphone 40 to generate sound signals in the second receiving state S2, wherein the method of the control module 20 switching modes may be controlled via a knob or function selector buttons. The hearing aid 1 of the present invention can also provide a function of detecting magnetic fields only according to specific situations (such as a meeting room with hearing loops).

It should be noted that, although exemplary embodiments of the present invention have been shown and described, the present invention is not limited to the described exemplary embodiments. Instead, it will be appreciated by those skilled in the art that changes may be made to these exemplary embodiments without departing from the principles and spirit of the invention, the scope of which is defined by the claims and their equivalents.

What is claimed is:

1. A hearing aid used to detect a magnetic field and help hearing-impaired listeners hear sounds, wherein the hearing aid comprises:
a plurality of magnetic sensors used to detect a magnetic field and generate a plurality of magnetic field signals;
a signal processing module electrically connected to the plurality of magnetic sensors and used to receive a plurality of magnetic field signals so as to generate a first sound signal;
a microphone used to receive an external sound and transform it to a third sound signal;
a sound processing module used to receive the third sound signal and modify it with frequency processing so as to generate a fourth sound signal;
an amplifier used to receive the first sound signal and the fourth sound signal;
a speaker electrically connected to the amplifier; and
a control module connected to the plurality of magnetic sensors the signal processing module, the microphone or the sound processing module, and used to control the generation of the first sound signal and the fourth sound signal so as to come to a first receiving state and a second receiving state, wherein:
in the first receiving state,
the amplifier is used to receive the first sound signal so as to make the speaker receive the first sound signal; and
in the second receiving state,
the amplifier is used to receive the fourth sound signal so as to make the speaker receive the fourth sound signal.

2. The hearing aid as claimed in claim 1, wherein the signal processing module further comprises calculating the plurality of magnetic field signals so as to obtain a magnetic field signal sum, and generating the first sound signal through the magnetic field signal sum.

3. The hearing aid as claimed in claim 2, wherein the plurality of magnetic sensors are not mutually parallel.

4. The hearing aid as claimed in claim 3, wherein the plurality of magnetic sensors are mutually perpendicular.

5. The hearing aid as claimed in claim 4, wherein the number of the plurality of magnetic sensors is 2 or 3.

6. A hearing aid used to detect a magnetic field and help hearing-impaired listeners hear sounds, wherein the hearing aid comprises:
a plurality of magnetic sensors used to detect a magnetic field and generate a plurality of magnetic field signals;
a signal processing module electrically connected to the plurality of magnetic sensors and used to receive a plurality of magnetic field signals so as to generate a first sound signal;
a microphone used to receive an external sound and transform it to a third sound signal;
a sound processing module,
used to receive the first sound signal and modify it with frequency processing so as to generate a second sound signal;
used to receive the third sound signal and modify it with frequency processing so as to generate a fourth sound signal;
an amplifier used to receive the second sound signal or the fourth sound signal;
a speaker electrically connected to the amplifier; and
a control module connected to the plurality of magnetic sensors, the signal processing module, the microphone or the sound processing module, and used to control the generation of the first sound signal and the fourth sound signal so as to come to a first receiving state and a second receiving state, wherein:
in the first receiving state,
the amplifier is used to receive the second sound signal so as to make the speaker receive the second sound signal; and
in the second receiving state,
the amplifier is used to receive the fourth sound signal so as to make the speaker receive the fourth sound signal.

7. The hearing aid as claimed in claim 6, wherein the signal processing module further comprises calculating the plurality of magnetic field signals so as to obtain a magnetic field signal sum, and generating the first sound signal through the magnetic field signal sum.

8. The hearing aid as claimed in claim 7, wherein the plurality of magnetic sensors are not mutually parallel.

9. The hearing aid as claimed in claim 8, wherein the plurality of magnetic sensors are mutually perpendicular.

10. The hearing aid as claimed in claim 9, wherein the number of the plurality of magnetic sensors is 2 or 3.

11. The hearing aid as claimed in claim 1, wherein the plurality of magnetic sensors use the Hall Effect, magneto-impedance effect, magneto-resistance effect, or micro fluxgate.

12. The hearing aid as claimed in claim 2, wherein the plurality of magnetic sensors use the Hall Effect, magneto-impedance effect, magneto-resistance effect, or micro fluxgate.

13. The hearing aid as claimed in claim 3, wherein the plurality of magnetic sensors use the Hall Effect, magneto-impedance effect, magneto-resistance effect, or micro fluxgate.

14. The hearing aid as claimed in claim 4, wherein the plurality of magnetic sensors use the Hall Effect, magneto-impedance effect, magneto-resistance effect, or micro fluxgate.

15. The hearing aid as claimed in claim 5, wherein the plurality of magnetic sensors use the Hall Effect, magneto-impedance effect, magneto-resistance effect, or micro fluxgate.

16. The hearing aid as claimed in claim 6, wherein the plurality of magnetic sensors use the Hall Effect, magneto-impedance effect, magneto-resistance effect, or micro fluxgate.

17. The hearing aid as claimed in claim 7, wherein the plurality of magnetic sensors use the Hall Effect, magneto-impedance effect, magneto-resistance effect, or micro fluxgate.

18. The hearing aid as claimed in claim 8, wherein the plurality of magnetic sensors use the Hall Effect, magneto-impedance effect, magneto-resistance effect, or micro fluxgate.

19. The hearing aid as claimed in claim 9, wherein the plurality of magnetic sensors use the Hall Effect, magneto-impedance effect, magneto-resistance effect, or micro fluxgate.

20. The hearing aid as claimed in claim 10, wherein the plurality of magnetic sensors use the Hall Effect, magneto-impedance effect, magneto-resistance effect, or micro fluxgate.
